(19) United States
(12) Patent Application Publication
(10) Pub. No.: US 2008/0157588 A1
(43) Pub. Date: Jul. 3, 2008

(54) Track shoe having integral, trapezoid-shaped teeth

(76) Inventor: Modest Izrailevich Lyasko, Falls Church, VA (US)

Correspondence Address: CATERPILLAR/FINNEGAN, HENDERSON, L.L.P., 901 New York Avenue, NW, WASHINGTON, DC, 20001-4413, US

(21) Appl. No.: 11/647,140

(22) Filed: Dec. 29, 2006

(51) Int. Cl. B62D 55/26

(52) U.S. Cl. 305/201; 305/185

(57) ABSTRACT

A track shoe for connection to a chain link is disclosed. The track shoe may have a generally planar base portion configured to span two opposing elements of the chain link. The base portion may have a leading edge, a trailing edge, and opposing side edges connecting the leading and trailing edges. The track shoe may also have an integral grouser bar extending substantially perpendicularly from a ground-engaging surface of the base portion and extending transversely across the ground-engaging surface between the side edges. The grouser bar may have a plurality of integral teeth fabricated with a trapezoidal shape, when viewed from the leading and trailing edges.

### TECHNICAL FIELD

The present disclosure relates generally to a ground-engaging shoe for the tracked undercarriage of a mobile machine and, more particularly, to a track shoe having trapezoid-shaped teeth, which are integrally fabricated with the track shoe.

### BACKGROUND

A track type or crawler type machine utilizes chains on either side of the machine that are connected to ground engaging elements known as shoes to move the machines. Specifically, a sprocket driven by an engine of the machine engages links of the chain to translate the chain about spaced apart pulley mechanisms. As the chain translates about the pulley mechanisms, the connected shoes engage a work surface under the machine to transmit torque from the sprocket to the surface in a direction opposite the desired travel of the machine, thereby propelling the machine. Depending on the weight of the machine, size and shape of the track shoe, and characteristics of the work surface on which the machine is operating, the machine may occasionally lose traction or slip. That is, it may be possible for the sprockets to drive the track shoes, without causing a corresponding travel motion of the machine. Depending on the frequency and magnitude of slip, productivity and efficiency of the machine can be adversely affected.

In order to minimize slip and improve machine productivity and efficiency in poor tractive conditions, some manufacturers have begun producing track shoes having integral teeth. One example of such a track shoe is disclosed in U.S. Pat. No. 4,637,665 (the '665 patent) issued to Burdick et al. on Jan. 20, 1987. In the '665 patent, Burdick et al. describes and illustrates a track assembly for a track-type vehicle that has a plurality of first and second distinct individual track shoes joined together to form an endless loop. The first shoes have a projecting grouser bar, with a first plurality of triangularly-shaped teeth, and the second shoes have a projecting grouser bar with a second plurality of triangularly-shaped teeth. Each of the teeth have a leading end portion, a trailing end portion, and a relatively sharp tip edge between the two end portions. The sharp tip edge slopes downward from the leading end portion to the trailing end portion at an acute angle. Each tooth has a height of between 45-75% of an overall grouser bar height. The first and second shoes are arranged in an alternating pattern with the teeth of the first shoes staggered relative to the teeth of the second shoes. The toothed grouser bar is designed to penetrate the surface and provide the necessary traction to effectively perform work functions in poor conditions such as in ice, hard or compacted earth, and certain rocks and minerals.

Although the toothed track shoe of the '665 patent may improve traction under some conditions, it may be sub-optimally shaped and prone to accelerated wear. In particular, the dimensions and spacing of the teeth may be inadequately selected for maximum surface penetration. And, because the teeth are triangularly shaped, the tips thereof may quickly wear. Even though it has been shown that teeth, which have been worn to a blunt shape, still provide tremendous benefit over track shoes without any teeth, the time and material utilized to fabricate the pointed teeth, because of the wear rate-thereof, may have been wasted.

The disclosed track shoe design is directed to overcoming one or more of the problems set forth above.

### SUMMARY OF THE INVENTION

In one aspect, the present disclosure is directed to a track shoe for connection to a chain link. The track shoe may include a generally planar base portion configured to span two opposing elements of the chain link. The base portion may have a leading edge, a trailing edge, and opposing side edges connecting the leading and trailing edges. The track shoe may also include an integral grouser bar extending substantially perpendicularly from a ground-engaging surface of the base portion and extending transversely across the ground-engaging surface between the side edges. The grouser bar may have a plurality of integral teeth fabricated with a trapezoidal shape, when viewed from the leading and trailing edges.

In another aspect, the present disclosure is directed to another track shoe for connection to a chain link. This track shoe may include a generally planar base portion configured to span two opposing elements of the chain link. The base portion may have a leading edge, a trailing edge, and opposing side edges connecting the leading and trailing edges. The track shoe may also include an integral grouser bar extending substantially perpendicularly from a ground-engaging surface of the base portion and extending transversely across the ground-engaging surface between the side edges. The grouser bar may have a plurality of integral teeth having a width at a tip end of each of the plurality of integral teeth in a direction substantially parallel with the grouser bar in the range of about 1.7-3.3 times greater than the distance between the tip ends of adjacent ones of the plurality of integral teeth.

### BRIEF DESCRIPTION OF THE DRAWINGS

FIG. 1 is a pictorial illustration of an exemplary disclosed machine;

FIG. 2a, is a side view pictorial illustration of an exemplary disclosed chain link and track shoe assembly for use with the machine of FIG. 1;

FIG. 2b is an oblique view illustration of the track shoe of FIG. 2; and

FIG. 3 is an oblique view illustration of a portion of an exemplary disclosed chain and track shoe assembly for use with the machine of FIG. 1.

### DETAILED DESCRIPTION

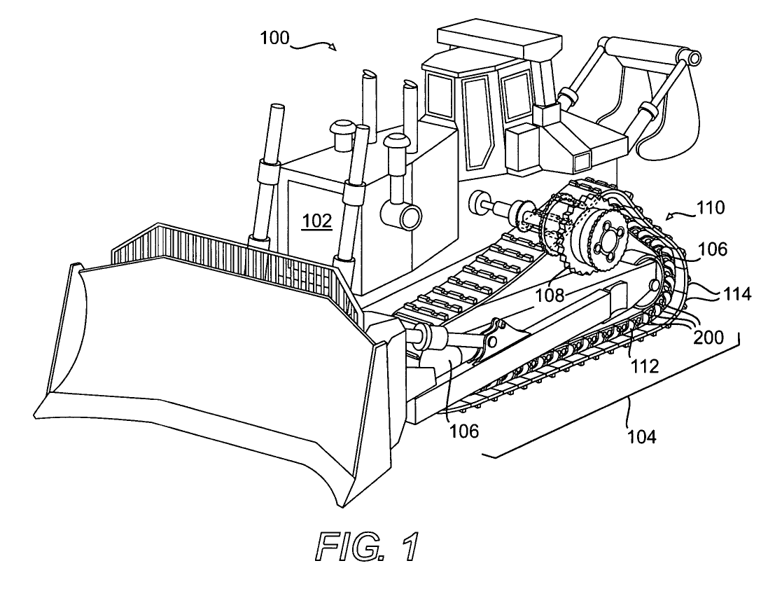

FIG. 1 illustrates a machine 100 having a power source 102 and a tracked undercarriage 104 driven by power source 102 and supported by spaced-apart pulley mechanisms 106. Machine 100 may be a mobile machine that performs some type of operation associated with an industry such as mining, construction, farming, or any other industry known in the art. For example, machine 100 may be an earth moving machine such as a dozer, a loader, an excavator, a motor grader, or any other earth moving machine. Power source 102 may be a combustion engine such as, for example, a diesel engine, a gasoline engine, a gaseous fuel-powered engine, or any other engine suitable for driving a tracked undercarriage. Power source 102 may also be a non-combustion source of power such as, for example, a fuel cell, a power storage device, or any other source of power known in the art. Power source 102 may deliver torque to tracked undercarriage 104 by way of opposing sprockets 108 (only one shown in FIG. 1).

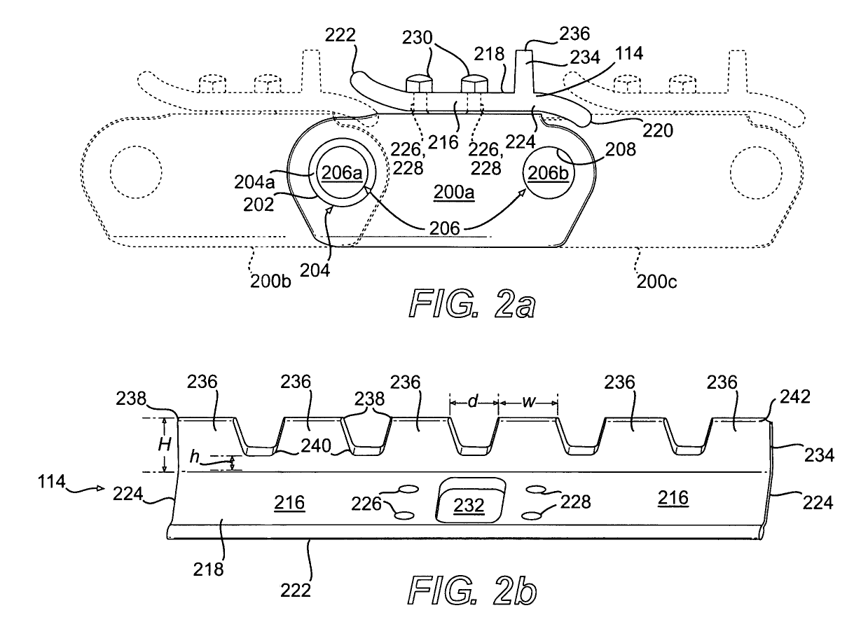

Tracked undercarriage 104 may include two separate continuous tracks 110 (only one shown in FIG. 1), each continuous track 110 including a chain 112 and a plurality of ground-engaging devices called track shoes 114. Each chain 112 may generally include links 200 composed of two opposing link elements. FIG. 2a illustrates one link element 200a, where the corresponding opposing link element is understood to be blocked from view by link element 200a. Links 200 may be interconnected by way of rod members consisting of a substantially cylindrical bushing 204 and a substantially cylindrical pin 206. Each bushing 204 may have an inner and an outer diameter, the inner diameter sized to receive an outer diameter of pin 206. Each link element 200a may include a first hole 202 fitted to receive a first bushing 204a sheathing a first pin 206a, and a second hole 208 fitted to receive a second pin 206b. The corresponding opposing link element of link element 200a may be disposed in the same general orientation as link element 200a and configured to similarly receive opposing ends of bushing 204a and second pin 206b. In general, bushings 204 and pins 206 may be related such that each pin 206 may freely rotate within an associated bushing 204, allowing consecutively connected links 200 to pivotally fasten to each other. For example, a second link element 200b may be connected end-to-end with link element 200a via pin 206a, and a third link element 200c may be connected end-to-end with link element 200a opposite second link element 200b via a bushing (not shown) sheathing second pin 206b. This arrangement may be repeated to form chain 112. Sprockets 108 may engage bushings 204 to translate chain 112 about pulley mechanisms 106.

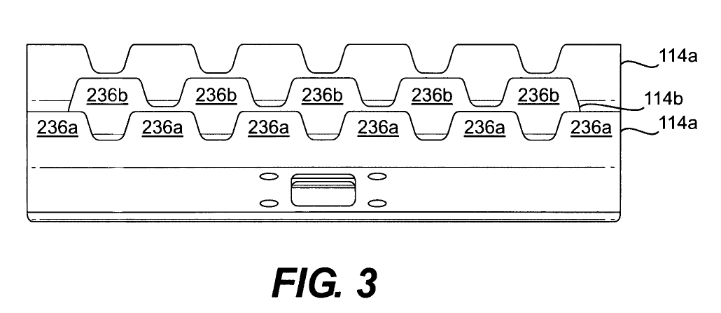

One track shoe 114 may be bolted to each pair of opposing link elements 200a. That is, track shoe 114 may include a substantially planar base portion 216 spanning the opposing paired link elements 200a, and having a ground-engaging surface 218, a leading edge 220, a trailing edge 222, opposing side edges 224 connecting leading edge 220 to trailing edge 222, a first set of through holes 226, and second set of through holes 228. Each set of through holes 226, 228 may be substantially aligned with side edges 224, but transversely spaced apart from each other relative to leading and trailing edges 220, 222. Multiple threaded fasteners 230, such as bolts or capscrews, may be received by each of the through holes 226, 228 to fasten track shoe 114 to link elements 200a. It is contemplated that tracked undercarriage 104 may include two or more different kinds of track shoes that alternate when fastened to chain 112, if desired. This configuration will be described in further detail with respect to FIG. 3.

As illustrated in FIG. 2b, track shoe 114 may further include an opening 232 substantially centered between first and second sets of through holes 226, 228 to allow snow, slush, or other loose material to pass through track shoe 114. It is contemplated that opening 232 may be disposed in a different position relative to first and second sets of through holes 226, 228 and/or that track shoe 114 may include additional openings, if desired. It is also contemplated that opening 232 may be omitted, if desired.

Track shoe 114 may also include an integral grouser bar 234 extending substantially perpendicularly from ground-engaging surface 218 and extending transversely across planar base portion 216 between side edges 224. Integral grouser bar 234 may be positioned between leading edge 220 and both sets of through holes 226, 228 such that it does not interfere with through holes 226, 228 or opening 232. It is also contemplated that integral grouser bar 234 may be positioned between each set of through holes 226, 228 or across the middle of track shoe 114.

Integral grouser bar 234 may include a plurality of teeth 236 integrally fabricated with grouser bar 234 to have a substantially trapezoidal shape when viewed from leading edge 220 or trailing edge 222. Integral teeth 236 may also be substantially equally spaced along integral grouser bar 234. In a preferred embodiment, integral grouser bar 234 may include at least three integral teeth 236.

In one embodiment of the present disclosure, track shoe 114 may be fabricated such that a distance H from ground-engaging surface 218 to a tip end 238 of each of the plurality of integral teeth 236 may be in the range of about 2-4 times greater than a distance h measured from ground-engaging surface 218 to a base end 240 of each of the plurality of integral teeth 236. That is, track shoe 114 may be fabricated such that the ratio H/h may be in the range of about 2-4. In a more preferred embodiment, track shoe 114 may be fabricated such that distance H may be about three times greater than distance h. That is, track shoe 114 may be fabricated such that the ratio H/h may more preferably be about three. Experience has shown that when the ratio H/h is much greater than three, integral teeth 236 may break off of integral grouser bar 234 at an unacceptable rate. Conversely, experience has also shown that when the ratio H/h is much less than three, integral teeth 236 may not penetrate surfaces sufficiently to give machine 100 acceptable traction.

Further, track shoe 114 may be fabricated such that a width w at tip end 238 of each of the plurality of integral teeth 236 in a direction substantially parallel with integral grouser bar 234 may be in the range of about 1.6-3.3 times greater than a distance d between tip ends 238 of adjacent ones of the plurality of integral teeth 236. That is, track shoe 114 may be fabricated such that the ratio w/d may be in the range of about 1.6-3.3. In a more preferred embodiment, track shoe 114 may be fabricated such that width w may be about 2.4 times greater than distance d. That is, track shoe 114 may be fabricated such that the ratio w/d may more preferably be about 2.4. Experience has shown that when the ratio w/d is much greater than or less than 2.4, integral teeth 236 may provide unacceptable traction to work machine 100. Further, experience has shown that when the ratio w/d is much less than 2.4, the energy expended in propelling machine 100 may result in unacceptable slip of machine 100 and unacceptable wear of integral grouser bar 234.

An end surface 242 of each of the plurality of integral teeth 236 may be substantially planar and parallel with ground-engaging surface 218. It is contemplated, however, that end surface 242 may slope downwardly at an acute angle (not shown) toward ground-engaging surface 218 from leading edge 220 to trailing edge 222 to make each tooth 234 more aggressive such that integral grouser bar 234 may penetrate more readily into a ground surface, if desired.

As illustrated in FIG. 3, alternating track shoes 114a, 114b may be fabricated such that integral teeth 236a of first track shoe 114a may be staggered in position relative to the integral teeth 236b of second track shoe 114b. That is, the open paths between adjacent integral teeth 236a of first track shoe 114a may be blocked by integral teeth 236b of second track shoe 114b. By staggering the integral teeth 336b of second track shoe 114b, traction and stability may be added to machine 100. In particular, as chain 112 translates about pulley mechanisms 106 while machine 100 is on a soft, unstable, or sloped ground surface, integral teeth 236a may slip on the ground surface and remove a layer of the ground surface where end surfaces 242 are engaged, thus leaving less ground surface for engagement by successive integral teeth 236a. There may remain, however, some ground surface between the areas where integral teeth 236 had removed ground surface. Staggered integral teeth 236b may then engage this remaining ground surface to propel machine 100. It is contemplated that only one type of track shoe 114 may alternatively be fabricated, thus reducing the cost of manufacture of machine 100.

The size and shape of integral teeth 236 may change with wear of track shoe 114. For example, after a period of use, integral teeth 236 may wear such that end surface 242 is eroded leaving track shoe 114 with shorter integral teeth dimensions H, longer tip end widths w, and smaller distances d between tip ends 238 of adjacent integral teeth 236. More specifically, the ratio H/h may decrease with use of track shoe 114 and the ratio w/d may increase with use of track shoe 114. It is contemplated, however, that with relatively uniform wear across each integral tooth 234 may leave each integral tooth 234 with a substantially trapezoidal shape.

### INDUSTRIAL APPLICABILITY

The disclosed track shoe may be applicable to any tracked vehicle, and improve productivity and efficiency by increasing traction and minimizing slip. Further, the disclosed track shoe may decrease wear and increase track shoe life by reducing slip and providing stronger grouser teeth. The disclosed track shoe may also reduce component cost by minimizing fabrication of unnecessary tooth geometry that wears quickly. The operation of machine 100 will now be explained.

Track shoe 114 may provide propulsion to machine 100. For example, power unit 102 may drive opposing sprockets 108, which engage the rod members of chain 112. Thus, as opposing sprockets 108 rotate, chain 112 may be caused to rotate about spaced-apart pulley mechanisms 106, thus bringing a number of track shoes 114 into contact with a ground surface. As each track shoe 114 engages the ground surface, integral grouser bar 234 and teeth 236 may partially or fully penetrate the ground surface and apply a force to the penetrated ground surface in the direction of leading edge 220. Traction may result from this force and a combination of other forces such as, for example, friction, and machine 100 may be propelled in a direction substantially opposite to the force.

The dimensions of track shoe 114 may facilitate the propulsion of machine 100, as well as the productivity and efficiency thereof. More specifically, by choosing the ratio of H/h to be in the range of about 2-4, and more preferably about 3, integral teeth 236 of track shoe 114 may be able to penetrate the ground more efficiently, thus providing better traction, than a track shoe with a smaller H/h ratio. Further, the chosen ratio of H/h and trapezoid shape of integral teeth 236 may reduce breakage of integral teeth 236 from integral grouser bar 234 when compared with a track shoe with a larger H/h ratio.

In addition, by choosing the ratio of w/d to be in the range of about 1.6-3.3, and more preferably about 2.4, integral teeth 236 of track shoe 114 may penetrate the ground surface more efficiently, thus providing better traction over the course of its life than a track shoe with a larger or smaller w/d ratio. That is, even as integral teeth 236 wear with use of track shoe 114, track shoe 114 may provide better traction than a track shoe with a larger or smaller w/d ratio. Further, the chosen ratio of w/d may reduce the amount of energy expelled in propelling machine 100 over a track shoe with a smaller w/d ratio. This reduction of energy may result in decreased slip of machine 100 and decreased wear of integral grouser bar 134.

The disclosed track shoe may improve machine productivity and efficiency by increasing traction and reducing slippage. More specifically, the increased traction and reduced slippage may give the machine more stability on hard and/or side-sloped surfaces, or allow the machine to expend less energy in propelling itself and/or to move more weight. Also, because of the stronger integral grouser bar and integral teeth, the disclosed track shoe may experience decreased wear and/or an increased useful life span.

In addition, the blunt shape of the disclosed integral teeth may decrease the cost of manufacturing the disclosed track shoe in terms of time and materials spent. Further, the increased efficiency and lighter weight of the disclosed track shoe may decrease the amount of money spent on fuel per operation of the disclosed machine. More specifically, less materials may be needed to manufacture the disclosed blunt integral teeth, and less fuel may be needed to move the disclosed machine.

It will be apparent to those skilled in the art that various modifications and variations can be made to the disclosed track shoe. Other embodiments will be apparent to those skilled in the art from consideration of the specification and practice of the disclosed track shoe. It is intended that the specification and examples be considered as exemplary only, with a true scope being indicated by the following claims and their equivalents.

What is claimed is:

1. A track shoe for connection to a chain link, comprising:
a generally planar base portion configured to span two opposing elements of the chain link, the base portion having a leading edge, a trailing edge, and opposing side edges connecting the leading and trailing edges; and
an integral grouser bar extending substantially perpendicularly from a ground-engaging surface of the base portion and extending transversely across the ground-engaging surface between the side edges, wherein the grouser bar has a plurality of integral teeth fabricated with a trapezoidal shape, when viewed from the leading and trailing edges.

2. The track shoe of claim 1, wherein a first distance from the ground-engaging surface of the base portion to a tip end of each of the plurality of integral teeth is in the range of about 2-4 times greater than a second distance from the ground-engaging surface of the base portion to a base end of each of the plurality of integral teeth.

3. The track shoe of claim 2, wherein the first distance is more preferably about three times greater than the second distance.

4. The track shoe of claim 1, wherein a width at a tip end of each of the plurality of integral teeth in a direction substantially parallel with the grouser bar is in the range of about 1.6-3.3 times greater than a distance between the tip ends of adjacent ones of the plurality of integral teeth.

5. The track shoe of claim 4, wherein the width is more preferably about 2.4 times greater than the distance.

6. The track shoe of claim 1, wherein the plurality of integral teeth includes at least three integral teeth.

7. The track shoe of claim 1, further including a first set of through holes substantially aligned with the opposing side edges, and a second set of through holes substantially aligned with the opposing side edges and transversely spaced apart from first set of through holes relative to the leading and trailing edges.

8. The track shoe of claim 7, further including a central opening disposed between the first and second sets of through holes.

9. A track shoe for connection to a chain link, comprising:
a generally planar base portion configured to span two opposing elements of the chain link, the base portion having a leading edge, a trailing edge, and opposing side edges connecting the leading and trailing edges; and
an integral grouser bar extending substantially perpendicularly from a ground-engaging surface of the base portion and extending transversely across the ground-engaging surface between the side edges, wherein the grouser bar has a plurality of integral teeth having a width at a tip end of each of the plurality of integral teeth in a direction substantially parallel with the grouser bar in the range of about 1.6-3.3 times greater than the distance between the tip ends of adjacent ones of the plurality of integral teeth.

10. The track shoe of claim 9, wherein the width is more preferably about 2.4 times greater than the distance between the tip ends.

11. The track shoe of claim 9, wherein a distance from the ground-engaging surface of the base portion to a tip end of each of the plurality of integral teeth is in the range of about 2-4 times greater than a distance from the ground-engaging surface of the base portion to a base end of each of the plurality of integral teeth.

12. The track shoe of claim 11, wherein the distance from the ground-engaging surface of the base portion to a tip end of each of the plurality of integral teeth is more preferably about three times greater than the distance from the ground-engaging surface to the base end of each of the plurality of integral teeth.

13. The track shoe of claim 9, wherein the plurality of integral teeth includes at least three integral teeth.

14. The track shoe of claim 9, further including a first set of through holes substantially aligned with the opposing side edges, and a second set of through holes substantially aligned with the opposing side edges and transversely spaced apart from first set of through holes relative to the leading and trailing edges.

15. The track shoe of claim 14, further including a central opening disposed between the first and second sets of through holes.

16. An endless track for a crawler-type machine, comprising:
a chain having a plurality of links, wherein each of the plurality of links includes opposing elements connected to opposing elements of an adjacent one of the plurality of links;
a first shoe having a generally planar first base portion configured to span the two opposing elements of one of the plurality of links, the first base portion having a leading edge, a trailing edge, and opposing side edges connecting the leading and trailing edges;
a first integral grouser bar extending substantially perpendicularly from a ground-engaging surface of the first base portion and extending transversely across the ground-engaging surface of the first base portion between the side edges of the first base portion, wherein the first integral grouser bar has a first plurality of integral teeth fabricated with a trapezoidal shape, when viewed from the leading and trailing edges;
a second shoe having a generally planar second base portion configured to span the two opposing elements of another of the plurality of links, the second base portion having a leading edge, a trailing edge, and opposing side edges connecting the leading and trailing edges of the second base portion; and
a second integral grouser bar extending substantially perpendicularly from a ground-engaging surface of the second base portion and extending transversely across the ground-engaging surface of the second base portion between the side edges of the second base portion, wherein the second grouser bar has a second plurality of integral teeth having a width at a tip end of each of the second plurality of integral teeth in a direction substantially parallel with the second grouser bar in the range of about 1.6-3.3 times greater than the distance between the tip ends of adjacent ones of the second plurality of integral teeth.

17. The endless track of claim 16, wherein the width is more preferably about 2.4 times greater than the distance between the tip ends of adjacent ones of the second plurality of integral teeth.

18. The endless track of claim 16, wherein a distance from the ground-engaging surface of the first base portion to a tip end of each of the first plurality of integral teeth is in the range of about 2-4 times greater than the distance from the ground-engaging surface of the first base portion to a base end of each of the first plurality of integral teeth.

19. The endless track of claim 18, wherein the distance from the ground-engaging surface of the first base portion to the tip end of each of the first plurality of teeth is more preferably about three times greater than the distance from the ground-engaging surface of the first base portion to the base end of each of the first plurality of teeth.

20. The endless track of claim 16, wherein the first plurality of teeth are generally staggered relative to the second plurality of teeth when assembled to the chain.
